(19) United States
(12) Patent Application Publication
(10) Pub. No.: US 2012/0292359 A1
(43) Pub. Date: Nov. 22, 2012

(54) MEANS FOR MAGNETICALLY HOLDING AN OBJECT IN PLACE ON A VEHICLE

(76) Inventor: JOHN O'DELL, Arlington, NE (US)

(21) Appl. No.: 13/546,473

(22) Filed: Jul. 11, 2012

Related U.S. Application Data
(63) Continuation-in-part of application No. 12/928,662, filed on Dec. 16, 2010.

(51) Int. Cl. B60R 11/00

(52) U.S. Cl. 224/403; 224/562

(57) ABSTRACT

An object such as a fluid container, tool box, tackle box, etc. has a magnet associated therewith so that the object may be placed on the floor of a truck box or on the floor of a vehicle or the floor of a trailer or on a metal surface of a vehicle so that the object will be held in place during travel of the vehicle or trailer.

### CROSS REFERENCE TO RELATED APPLICATION

This is a Continuation-In-Part of application Ser. No. 12/928,662 filed Dec. 16, 2010, entitled A MEANS FOR MAGNETICALLY HOLDING AN OBJECT IN PLACE ON A VEHICLE.

### BACKGROUND OF THE INVENTION

1. Field of the Invention

This invention relates to a means for magnetically holding an object in place on a vehicle. More particularly, this invention relates to a means for . magnetically holding gas containers, tool boxes, tackle boxes, etc. in place on a truck box floor, a trunk of a vehicle, the floor or bed of a trailer or on a supporting surface on a vehicle.

2. Description of the Related Art

Objects or items such as gas containers, tool boxes, tackle boxes, tools, etc. are frequently placed on the floor of a pickup truck box or trailer. During travel of the truck or trailer, the objects slide around on the floor of the truck box or trailer and sometimes overturn. If the object is a gas container, the gas therein may spill therefrom which creates a hazard. If the object is a toolbox, tackle box, etc., the items in the box may become entangled should the box overturn. Even if the objects do not overturn, the shifting of the objects during travel of the vehicle or trailer makes it difficult to retrieve the objects at the arrival destination.

The above-named objects are sometimes placed in the trunk of an automobile and sometimes shift around or overturn during travel of the automobile. The above-named objects are also sometimes placed on a skid-steer tractor, an agricultural tractor or an ATV. In such a case, it is difficult to maintain the objects in place during travel of the same.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In the following specification, several different embodiments are disclosed. In one embodiment, a means is provided for magnetically holding an object in place on a vehicle or trailer with that object being a tool; cooler chest; gas can; water jug; basket; box; pet carrier or kennel; bait bucket; bucket; gas or charcoal grill; case for tools such as chain saws, etc.; fire extinguisher; racks for shovels, rakes, ladders, brooms, fishing poles, etc.; tailgating items such as umbrellas, flags, canopies, etc.; propane tank; truck bed divider; camping objects such as fans or lanterns, etc. If the object is a liquid container such as a gas container, the container includes a bottom, upstanding side walls and a top portion with a pour/fill opening formed therein. A magnet is secured to the bottom of the gas container with the magnet of the gas container magnetically adhering to container to the floor of the truck box, the floor of a trailer or the floor of a trunk of a vehicle. The magnet may be secured to the bottom of the container or embedded in the bottom of the container. The magnet may also be secured to any convenient part of the object.

In another embodiment, the liquid container, tool box, tackle box, etc. is magnetically attached to a supporting surface on a vehicle such as a skid-steer tractor, an agricultural tractor, etc. Other embodiments are also disclosed:

It is therefore a principal object of the invention to provide an improved means for magnetically holding an object in place on a vehicle or trailer.

A further object of the invention is to provide a means for magnetically holding an object in place on the floor of a truck box.

A further object of the invention is to provide a means for magnetically holding an object in place in the trunk of an automobile.

A further object of the invention is to provide a means for magnetically holding an object in place on the floor or bed of a truck.

A further object of the invention is to provide a means for magnetically holding an object in place on a vehicle by securing a magnet to the bottom of the object whether the object is a fluid container, tackle box, tool box or the like.

A further object of the invention is to provide a means for magnetically holding an object in place on a vehicle which prevents the object from sliding or moving on its supporting surface during travel of the vehicle.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a bottom perspective view of a liquid container such as a gas container having a magnet secured thereto;

FIG. 2 is a partial sectional view illustrating a magnet secured to the bottom of a liquid container;

FIG. 3 is a partial sectional view illustrating a liquid container having a recessed bottom wall having a magnet secured thereto;

FIG. 4 is a view similar to FIGS. 2 and 3 except that the magnet is embedded in the bottom of the container;

FIG. 5 is a bottom perspective view of a tool box or tackle box;

FIG. 6 is a partial sectional view of the box of FIG. 5 illustrating a magnet secured to the bottom thereof;

FIG. 7 is a view similar to FIG. 6 except that the magnet is embedded in the bottom of the box;

FIG. 8 is a rear perspective view of a truck having the container of FIG. 1 magnetically secured to the floor of the box of the truck;

FIG. 9 is partial rear perspective view of a truck illustrating a flexible magnetic pad mounted on the floor of the vehicle;

FIG. 10 is a partial end view of the structure of FIG. 9;

FIG. 11 is a partial rear view of a truck having a liner positioned in the box thereof having magnets embedded therein; and

FIG. 12 is an end view of the structure of FIG. 11.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

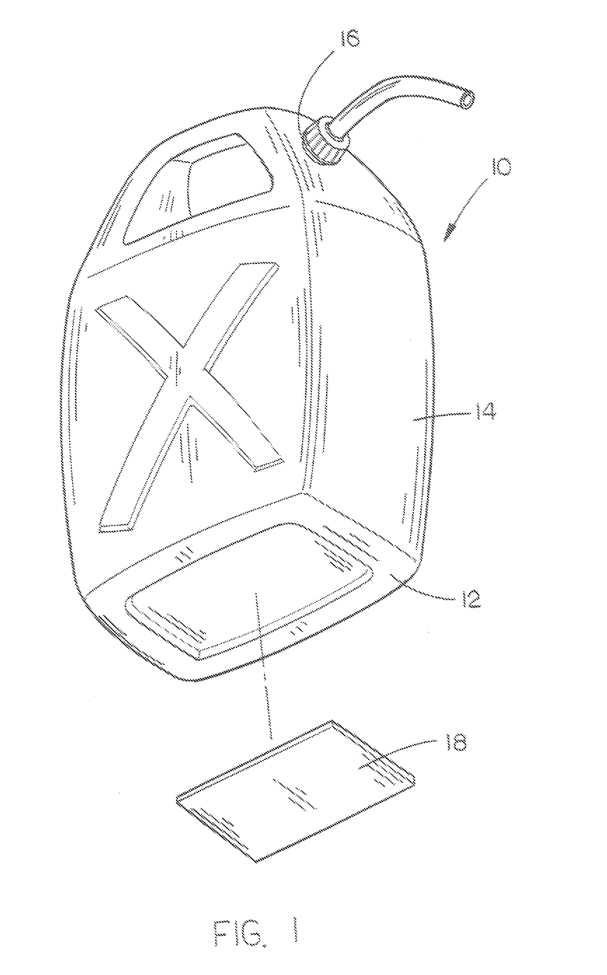

In FIG. 1, the numeral 10 refers to an object or item such as a liquid container and more particularly to a gas container having a bottom 12, upstanding side walls 14, and a fill/discharge opening 16 at its upper end. The numeral 18 refers to a magnet which is secured to the bottom 12 of the container 10 by any convenient means such as by a suitable adhesive or the like.

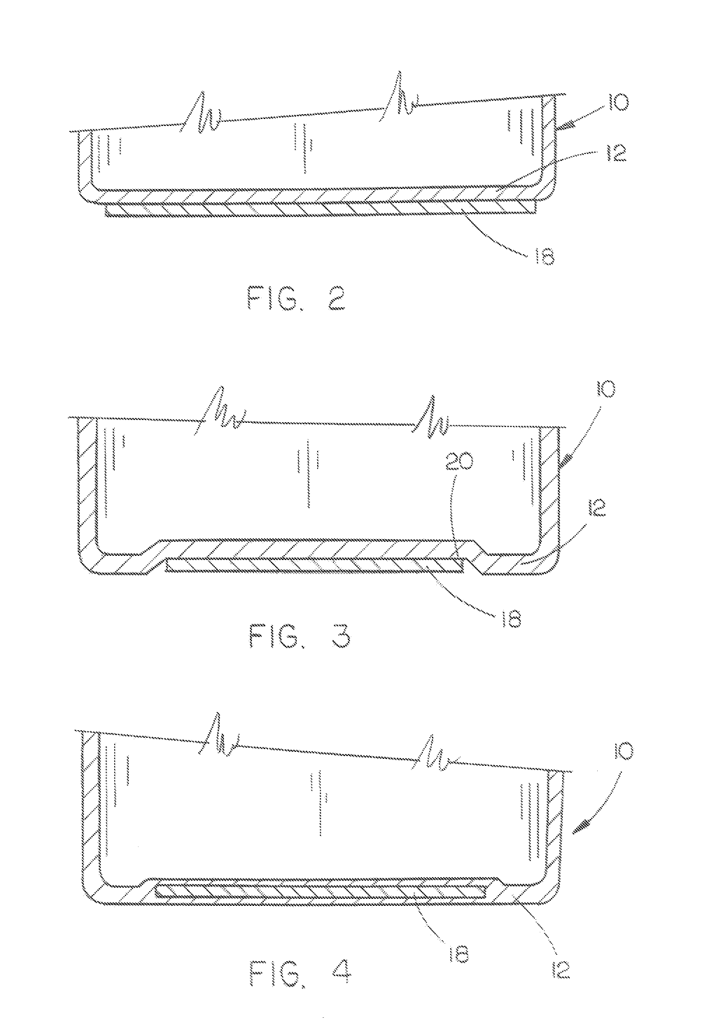

In FIG. 2, the container 10 is shown to have a flat bottom 12 with the magnet 18 being secured to the lower surface thereof. In FIGS. 1 and 3, the bottom 12 of the container 10 is shown to have a recessed area 20 formed in the bottom thereof with the magnet 18 being received in the recessed area 20. In FIG. 4, the container 10 is shown to have the magnet 18 embedded in the bottom 12.

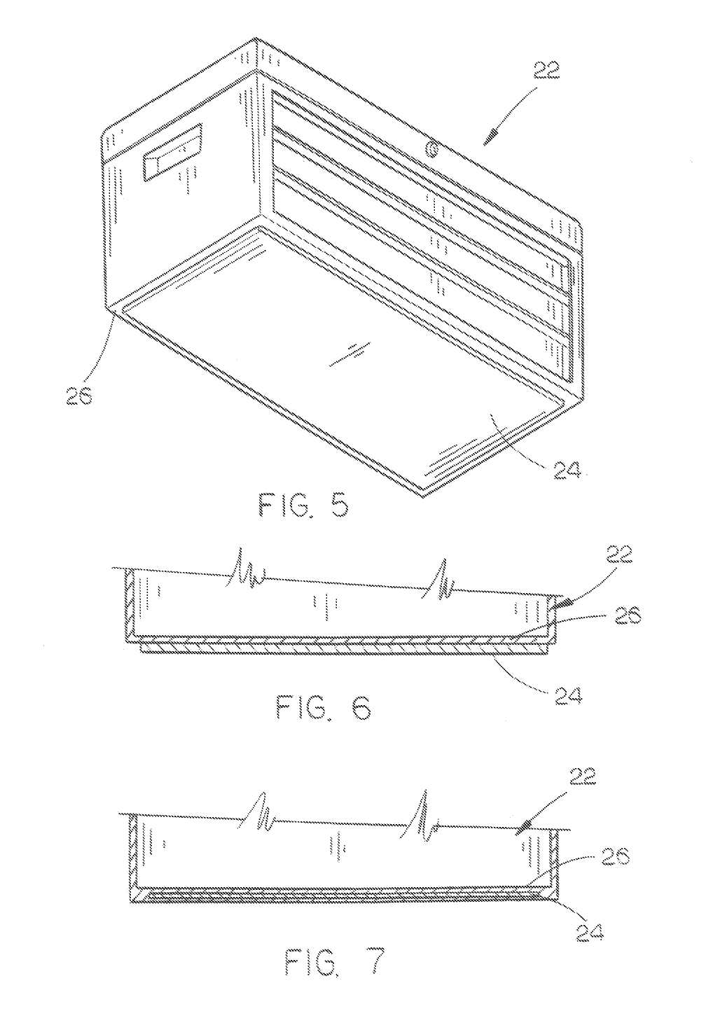

In FIG. 5, a tool box or tackle box 22 is illustrated which has a magnet 24 secured to the bottom 26 of the box 22. FIG. 6 illustrates that the box 22 has a flat bottom 26 with the magnet 24 being secured to the underside of the bottom 26 by a suitable adhesive or the like. In FIG. 7, the magnet 24 is shown to be embedded in the bottom 26.

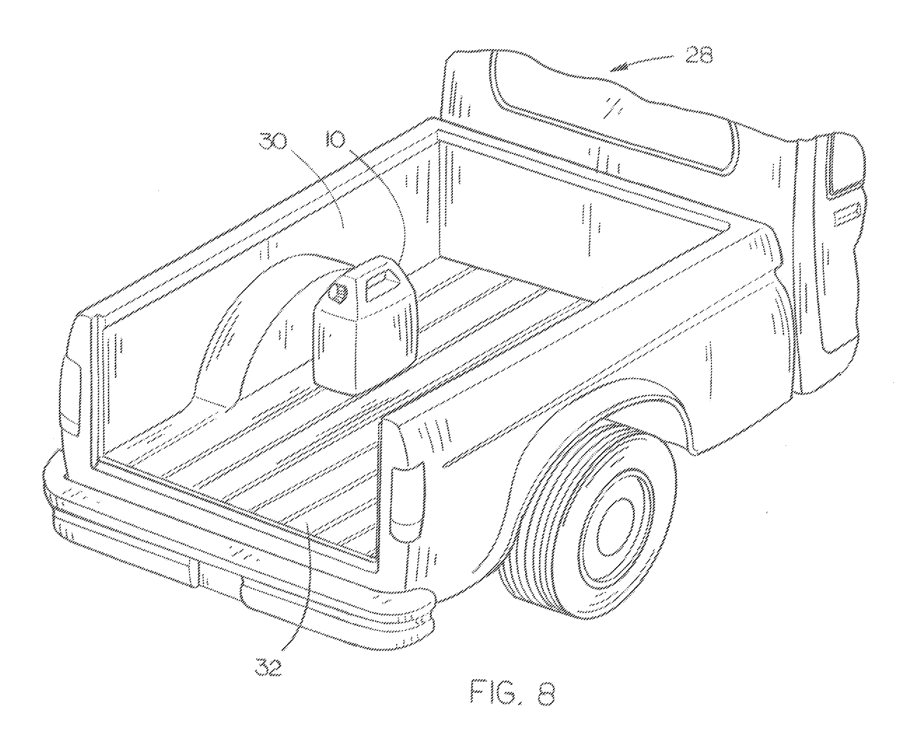

Referring now to FIG. 8, the numeral 28 refers to a vehicle such as a truck having a box 30 including a floor 32 which is normally constructed of a metal material. As seen in FIG. 8, the container 10 is positioned on the floor 32 with the magnet 18 thereof magnetically holding the container 10 in place with respect to the metal floor 32.

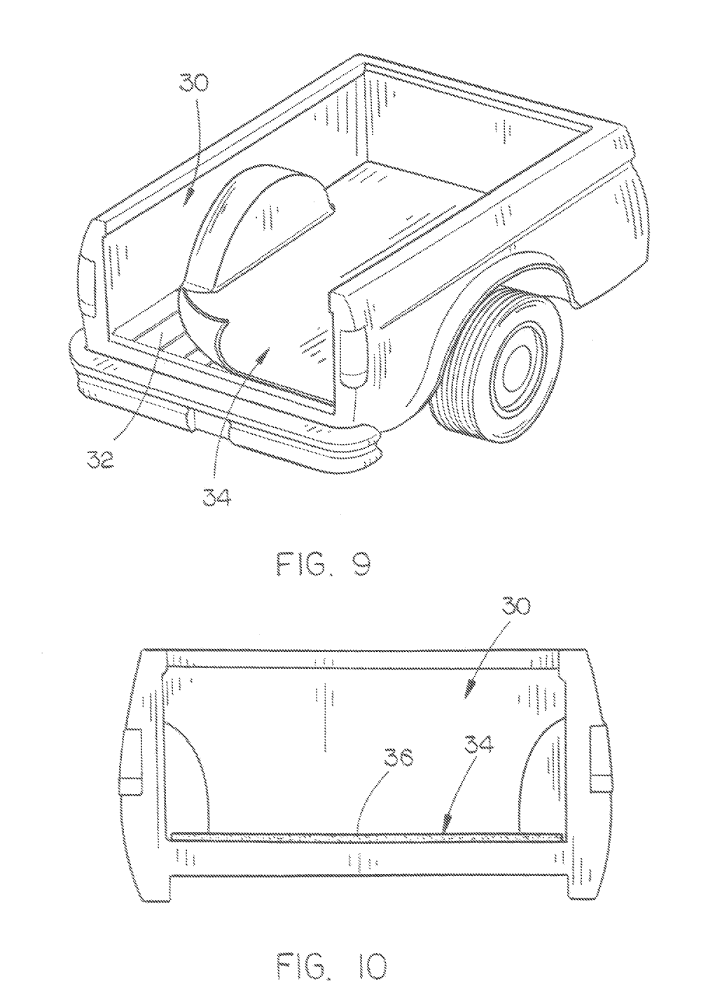

In FIG. 9, the numeral 34 refers to a flexible magnetic pad which is magnetically held onto the floor 32 of the box 30. As seen in FIG. 10, the pad 34 has magnetic particles 36 embedded therein.

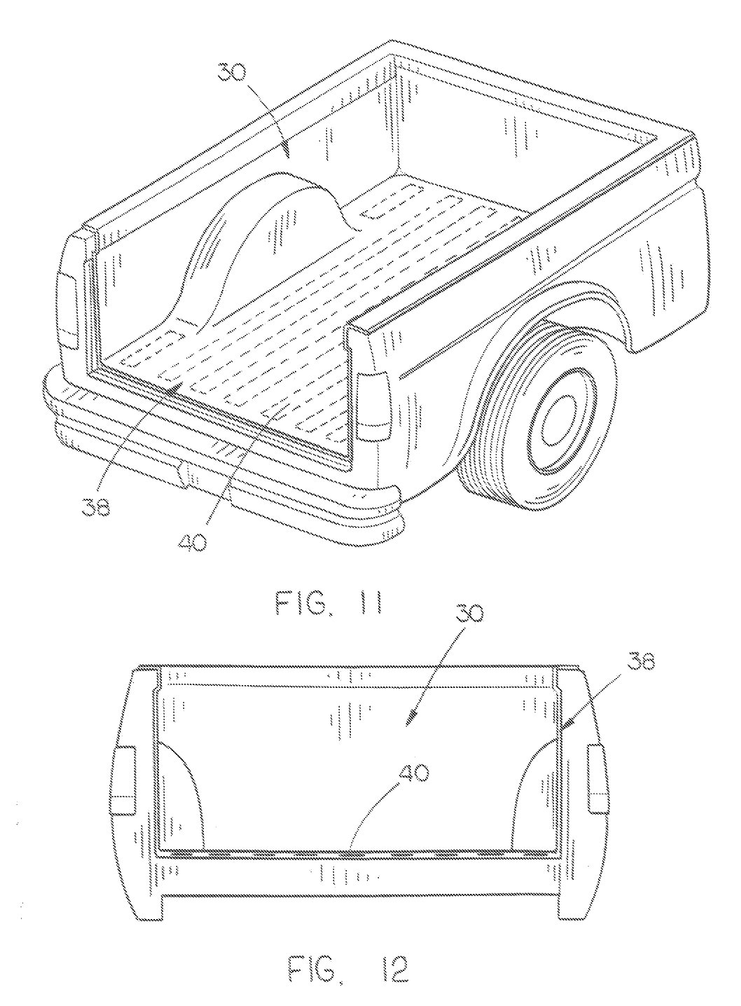

In FIG. 11, the box 30 is shown to have a protective liner 38 positioned in the box 30 with the liner 38 having magnets 40 embedded therein.

This invention will also work equally well to hold an object in place on the floor or bed of a trailer.

The object may be a tool; cooler chest; gas can; water jug; basket; box; pet carrier or kennel; bait bucket; bucket; gas or charcoal grill; case for tools such as chain saws, etc.; fire extinguisher; racks for shovels, rakes, ladders, brooms, fishing poles, etc.; tailgating items such as umbrellas, flags, canopies, etc.; propane tank; truck bed divider; camping items such as lanterns or fans, etc.

Thus it can be seen that when the liquid container 10 or the tool box or tackle box 22 is placed on the floor of a truck or trailer, the magnets associated therewith magnetically hold the object in place on the floor of the truck or trailer which prevents the object from sliding around on the floor of the box or floor of the trailer and which prevents the object 10 from overturning. Although only liquid containers, tool boxes and tackle boxes have been shown in the drawings, the invention hereof will work with other objects such as set forth above which are placed on the floor of the vehicle or trailer. Further, the objects having the magnets associated therewith may be placed in the trunk of a vehicle with the magnets associated therewith holding the objects in place on the floor of the vehicle trunk.

It can also be seen that when the truck box has a protective liner associated therewith, the objects will be held in place during travel of the vehicle.

Additionally, if a liquid container, tool box, tackle box, etc. is to be secured to a vehicle such as a garden tractor, agricultural tractor, skid-steer tractor or the like, the object with the magnets associated therewith may be firmly held in place on a suitable metal surface on the vehicle.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. An object for selective attachment to a metal surface of a vehicle with the object having a magnet secured thereto so that the object may be magnetically affixed to the metal surface of the vehicle to maintain the object in position on the metal surface of the vehicle.

2. The structure of claim 1 wherein the object is a cooler chest.

3. The structure of claim 1 wherein the object is a water jug.

4. The structure of claim 1 wherein the object is a basket.

5. The structure of claim 1 wherein the object is a box.

6. The structure of claim 1 wherein the object is a pet carrier.

7. The structure of claim 1 wherein the object is a bait bucket.

8. The structure of claim 1 wherein the object is a bucket.

9. The structure of claim 1 wherein the object is a gas or charcoal grill.

10. The structure of claim 1 wherein the object is a case for tools.

11. The structure of claim 1 wherein the object is a carrying case.

12. The structure of claim 1 wherein the object is a fire extinguisher.

13. The structure of claim 1 wherein the object is a rack for shovels, or rakes, or brooms or fishing poles.

14. The structure of claim 1 wherein the object is a ladder.

15. The structure of claim 1 wherein the object is an umbrella.

16. The structure of claim 1 wherein the object is a flag.

17. The structure of claim 1 wherein the object is a canopy.

18. The structure of claim 1 wherein the object is a propane tank.

19. The structure of claim 1 wherein the object is a truck bed divider.

20. The structure of claim 1 wherein the object is a rack.

21. The structure of claim 1 wherein the object is camping gear.

22. The structure of claim 1 wherein the object is a lantern.

23. The structure of claim 1 wherein the object is a fan.
